(19) United States
(12) Patent Application Publication
(10) Pub. No.: US 2026/0159706 A1
(43) Pub. Date: Jun. 11, 2026

(54) ENVIRONMENTAL ATTRIBUTES FOR COATING MATERIALS

(71) Applicants: BASF SE, Ludwigshafen am Rhein (DE); BASF COATINGS GMBH, Münster (DE)

(72) Inventors: Matthijs GROENEWOLT, Muenster (DE); Oliver JOHANNPOETTER, Muenster (DE); Timo WEBER, Muenster (DE); Marco BENEN, Muenster (DE); Bastian GRUMBRECHT, Ludwigshafen (DE); Steffen Thomas KLOSTERHALFEN, Ludwigshafen (DE); Christian KRUEGER, Ludwigshafen (DE); Kurt WENZL, Ludwigshafen (DE); Ana ALBA PEREZ, Ludwigshafen (DE); Christopher Alec ANDERLOHR, Ludwigshafen (DE); Martin BINDER, Ludwigshafen (DE); Alessandro PISTILLO, Ludwigshafen (DE)

(21) Appl. No.: 18/721,636

(22) PCT Filed: Dec. 19, 2022
(86) PCT No.: PCT/EP2022/086699

§ 371 Date: Jun. 18, 2024

Related U.S. Application Data
(60) Provisional application No. 63/416,091, filed on Oct. 14, 2022.

(30) Foreign Application Priority Data
Dec. 21, 2021 (EP) 21216268.9
Dec. 21, 2021 (EP) 21216269.7
Dec. 21, 2021 (EP) 21216270.5
Dec. 21, 2021 (EP) 21216271.3
Dec. 21, 2021 (EP) 21216286.1
Dec. 21, 2021 (EP) 21216292.9
Dec. 21, 2021 (EP) 21216326.5
Dec. 21, 2021 (EP) 21216327.3
Dec. 21, 2021 (EP) 21216333.1
Apr. 4, 2022 (EP) 22166573.0
Apr. 12, 2022 (EP) 22167945.9
May 10, 2022 (EP) 22172609.4
May 10, 2022 (EP) 22172611.0
May 10, 2022 (EP) 22172615.1
May 10, 2022 (EP) 22172617.7
May 10, 2022 (EP) 22172619.3
Sep. 9, 2022 (EP) 22194793.0
Sep. 9, 2022 (EP) 22194800.3
Sep. 9, 2022 (EP) 22194808.6
Sep. 9, 2022 (EP) 22194815.1
Sep. 9, 2022 (EP) 22194818.5
Oct. 14, 2022 (EP) 22201672.7
Oct. 18, 2022 (EP) 22202183.4
Dec. 5, 2022 (EP) 22211421.7

(51) Int. Cl. C09D 7/80; B01F 33/84

(52) U.S. Cl. CPC C09D 7/80; B01F 33/8442

(57) ABSTRACT

Disclosed are systems for producing a coating material associated with a coating material passport or digital asset, methods for producing a coating material associated with a coating material passport or digital asset, apparatuses for generating a passport or digital asset associated with a coating material, computer-implemented methods for generating a coating material passport or digital asset, computer program elements for generating a coating material passport or digital asset, uses of a coating material associated with a coating material passport or digital asset, uses of a coating material passport or digital asset, products produced from the coating material associated with the coating material passport or digital asset, a coating material, a coating material passport or digital asset including one or more decentral identifier(s) and data related to environmental impact data, apparatuses for producing a product associated with the coating material passport or digital asset and methods for producing a product associated with the coating material passport or digital asset.

### TECHNICAL FIELD

The present disclosure relates to systems for producing a coating material associated with a coating material passport or digital asset, methods for producing a coating material associated with a coating material passport or digital asset, apparatuses for generating a passport or digital asset associated with a coating material, computer-implemented methods for generating a coating material passport or digital asset, computer program elements for generating a coating material passport or digital asset, uses of a coating material associated with a coating material passport or digital asset, uses of a coating material passport or digital asset, products produced from the coating material associated with the coating material passport or digital asset, a coating material, a coating material passport or digital asset including one or more decentral identifier(s) and data related to environmental impact data, apparatuses for producing a product associated with the coating material passport or digital asset and methods for producing a product associated with the coating material passport or digital asset.

### TECHNICAL BACKGROUND

In supply chains the environmental impact of each supply chain participants is of great interest. Specifically in the field of chemistry, coating materials are employed for a wide range of applications and are supplied to diverse value chains. In such complex systems transparency between value chain participants is hard to achieve.

### SUMMARY OF THE INVENTION

In one aspect disclosed is a system for producing a coating material associated with a coating material passport or a digital asset, the system comprising:
a chemical production network configured to produce the coating material from one or more input material(s) through one or more chemical process(es) of the chemical production network, wherein the one or more input material(s) and/or the one or more chemical process(es) are associated with environmental attribute(s);
a production operating apparatus configured to generate the coating material passport or digital asset by
   providing a decentral identifier associated with the produced coating material and the one or more environmental attribute(s) of the one or more input material(s) and/or the one or more chemical process(es);
   linking the decentral identifier and the environmental attribute(s);
optionally the chemical production network or a chemical production system configured to provide the produced coating material in association with the coating material passport or digital asset.

In another aspect disclosed is a system for producing a coating material associated with a coating material passport and/or a digital asset, the system comprising:
a chemical production network configured to produce the coating material from one or more input material(s) through one or more chemical process(es), wherein the one or more input material(s) and/or the one or more chemical process(es) are associated with environmental attribute(s);
a production operating apparatus configured to generate the coating material passport or digital asset by providing and/or linking a decentral identifier associated with the produced coating material and the one or more environmental attribute(s) associated with the one or more input material(s) and/or the one or more chemical process(es).

In another aspect disclosed is a method for producing a coating material associated with a coating material passport or a digital asset, wherein the method comprises:
producing the coating material from one or more input material(s) through one or more chemical process(es) of a chemical production network, wherein the one or more input material(s) and/or the one or more chemical process(es) are associated with environmental attribute(s);
generating the coating material passport or digital asset by
   providing a decentral identifier associated with the produced coating material and one or more environmental attribute(s) associated with the one or more input material(s) and/or the one or more chemical process(s);
   linking the decentral identifier and the one or more environmental attribute(s);
providing the produced coating material in association with the coating material passport or digital asset.

In another aspect disclosed is a method for producing a coating material associated with a coating material passport or a digital asset, wherein the method comprises:
producing the coating material from one or more input material(s) through one or more chemical process(es) of a chemical production network, wherein the one or more input material(s) and/or the one or more chemical process(es) are associated with environmental attribute(s),
generating the coating material passport or digital asset by providing and/or linking a decentral identifier associated with the produced coating material and one or more environmental attribute(s) of the one or more input material(s) and/or the chemical process(s).

In another aspect disclosed is an apparatus for generating a passport or digital asset associated with a coating material, wherein the coating material is produced from one or more input material(s) through one or more chemical process(es) of a chemical production network, wherein the one or more input material(s) and/or the one or more chemical process(es) are associated with environmental attribute(s), the apparatus comprising:
a decentral identity provider configured to provide a decentral identifier associated with the produced coating material and the one or more environmental attribute(s) of the one or more input material(s) and/or the one or more chemical process(s) used to produce the coating material;
an assignor configured to link the decentral identifier and the environmental attribute(s);
a passport provider configured to provide the coating material passport or digital asset in association with the produced coating material to a decentral network, wherein the environmental attribute(s) associated with the produced coating material is made accessible to a consumer of the produced coating material through the coating material passport or digital asset.

In another aspect disclosed is a method, e.g. a computer-implemented method, for generating a coating material passport or digital asset associated with a coating material, wherein the coating material is produced from one or more input material(s) through one or more chemical process(s) of a chemical production network, wherein the one or more input material(s) and/or the one or more chemical process(s) are associated with environmental attribute(s), the method comprising:
providing a decentral identifier associated with the produced coating material and one or more environmental attribute(s) of the one or more input material(s) and/or the one or more chemical process(s) used to produce the coating material;
linking the decentral identifier and the environmental attribute(s);
providing the coating material passport or digital asset in association with the produced coating material to a decentral network, wherein the environmental attribute(s) associated with the produced coating material is made accessible to a consumer of the produced coating material through the coating material passport or digital asset.

In another aspect disclosed is a computer element, such as a computer readable storage medium, a computer program or a computer program product, comprising instructions, which when executed by a computing node or a computing system, direct the computing node or computing system to carry out the steps of the computer-implemented methods disclosed herein.

In another aspect disclosed is a computer element, such as a computer readable storage medium, a computer program or a computer program product, comprising instructions, which when executed by the apparatuses disclosed herein, direct the apparatuses to carry out steps the apparatuses disclosed herein are configured to execute.

In another aspect disclosed is a coating material associated with a coating material passport or a digital asset as produced according to the methods disclosed herein. In another aspect disclosed a coating material associated with a coating material passport or a digital asset as produced according to the systems disclosed herein.

In another aspect disclosed is a coating material associated with a coating material passport or a digital asset, wherein the coating material is produced from one or more input material(s) through one or more chemical process(es) of a chemical production network, wherein the one or more input material(s) and/or the one or more chemical process(es) are associated with environmental attribute(s), wherein the coating material passport or digital asset includes a decentral identifier associated with the produced coating material and a link to environmental attribute(s) associated with one or more environmental attribute(s) of one or more input material(s) and/or one or more chemical process(es) used to produce the coating material.

In another aspect disclosed is a coating material passport as generated according to the methods and/or apparatuses disclosed herein.

In another aspect disclosed is a production system for producing a product from the coating material associated with the coating material passport or digital asset as provided according to the systems, apparatuses or methods disclosed herein. In another aspect disclosed is a production method for producing a product from the coating material associated with the coating material passport or digital asset as provided according to the systems, apparatuses or methods disclosed herein.

In another aspect disclosed is a use of the coating material associated with the coating material passport or digital asset as disclosed herein for producing a product from the coating material associated with the coating material passport or digital asset.

In another aspect disclosed is a use of the coating material passport or digital asset as disclosed herein for generating a product passport or digital asset associated with a product produced from the coating material associated with the coating material passport or digital asset. In another aspect disclosed is a method for using the coating material passport or digital asset generated according to the methods disclosed herein in the production of a product produced from the coating material associated with the coating material passport or digital asset.

In another aspect disclosed is a coating material associated with a coating material passport or digital asset including a decentral identifier associated with the coating material and linked to one or more environmental attribute(s) of the one or more input material(s) and/or the one or more chemical process(es) used to produce the coating material.

In another aspect disclosed is a use of the coating material associated with the coating material passport or digital asset for producing a product from the coating material and associating the coating material passport or digital asset with the product produced from the coating material. In another aspect disclosed is a use of the coating material associated with the coating material passport or digital asset for producing a product from the coating material and deriving a product passport or digital asset from the coating material passport or digital asset. In another aspect disclosed is a method for using the coating material associated with the digital asset for producing a product from the coating material as disclosed herein and deriving a digital asset associated with the product from the coating material passport or digital asset.

Any disclosure and embodiments described herein relate to the methods, the systems, chemical products, coating materials, coating material passports or digital assets, and the computer elements lined out above and below and vice versa. Advantageously, the benefits provided by any of the embodiments and examples equally apply to all other embodiments and examples.

### EMBODIMENT

In the following, embodiments of the present disclosure will be outlined by ways of embodiments and/or example. It is to be understood that the present disclosure is not limited to said embodiments and/or examples. All terms and definitions used herein are understood broadly and have their general meaning.

The methods, the systems, coating materials, coating material passports or digital assets, and the computer elements disclosed herein provide an efficient, secure and robust way for sharing or exchanging environmental impact data across different participant nodes in value chains. In particular, by providing coating material specific data via the respective coating material passport or digital asset, environmental impacts can be shared and made transparent from the coating material to the product produced from such coating material. The coating material passport or digital asset enables secure data exchange, since data access can be controlled by the coating material provider, e.g. the entity providing the coating material. The exchanged data assets can be specific to the coating material as produced and tailored to the needs of the consumer of said products. This way, an improved tracking and tracing of coating materials can be achieved by securely providing environmental impact data in diverse and highly complex value chains. The environmental impact of coating materials can hence be tracked leading to simpler, more efficient and sustainable handling of coating materials by value chain participants. For instance, the environmental impact data associated with the respective coating material may be used by the coating material consumer, such as a vehicle manufacturer or a bodyshop repairing vehicles, to select the appropriate coating material necessary to fulfil the required environmental impact of the resulting product, such as the coated vehicle or the repaired vehicle.

Coating materials may include liquid, paste-like or powdery materials which, when applied to at least part of the surface of a substrate, produce a coating with protective, decorative and/or other specific properties (see also DIN EN 971-1: 1996-09). Substrates may include metal substrates, plastic substrates and mixtures thereof. The substrates may be pretreated or may comprise at least one coating layer. The coating materials may be applied using commonly known application techniques, such as dipping, bar coating, spraying, rolling or the like. Machines may be stationary machines or movable machines. Stationary machines may include air conditioning devices, power units (nuclear, coal, natural gas, oil, wind, water, solar thermal, geothermal), generators, pumps, hydraulic power units, wind turbines, transformer station, thermal heat pumps, and compressors. Movable machines may include vehicles. Vehicles may include motor vehicles. Examples of motor vehicles may include motorcycles, cars, trucks, buses, vans, minivans, ATV (all-terrain vehicles) and mobility scooters for disabled people). Vehicles may include railed vehicles. Examples of railed vehicles may include trains and trams. Vehicles may include watercraft vehicles. Examples of watercraft vehicles may include ships, boats and underwater vehicles. Vehicles may include amphibious vehicles. Examples of amphibious vehicles may include screw-propelled vehicles and hovercraft. Vehicles may include aircrafts. Examples of aircrafts may include airplanes, helicopters and aerostats. Vehicles may include spacecraft. The stationary or movable machines may be driven by spark-ignited or self-ignition engines, two-or four stroke engines, electrical engines, fuel cells or combinations thereof (hybrid engines).

In an embodiment, the coating material associated with the coating material passport or digital asset may be selected from the group consisting of coating materials and coating material components. Coating materials may be selected from electrocoating materials, primer materials, primer-surfacer materials, filler materials, putty materials, basecoat materials, clearcoat materials or tinted clearcoat materials. For instance, the coating material may be a primer material. In another instance, the coating material may be an electrocoating material. In yet another instance, the coating material may be a clearcoat material. Coating material components may be selected from hardener compositions, additive compositions, thinners, reducers, spot blender compositions, pigment pastes or binder compositions. For instance, the coating material component may be a hardener composition. In another instance, the coating material component may be a binder composition. In yet another instance, the coating material component may be a thinner. In yet another instance, the coating material component may be a reducer. In yet another instance, the coating material component may be a spot blender composition. In yet another instance, the coating material component may be a pigment paste. In yet another instance, the coating material component may be an additive composition.

Electrocoating materials typically comprise an aqueous dispersion or emulsion of film-forming material(s), such as an epoxy resin, having ionic stabilization, such as anionic or cationic stabilization. The film-forming material(s) may be self-crosslinking or may be crosslinkable using a crosslinker. Electrocoating materials may further comprise pigments and/or crosslinking agent(s). The electrocoating materials may be formulated by mixing a binder dispersion comprising the film-forming material(s) and the crosslinker(s) with a pigment paste comprising at least one pigment. During electrodeposition, the electrocoating material is deposited onto a conductive substrate by submerging the substrate in an electrocoating bath containing the electrocoating material and then applying an electrical potential between the substrate and a pole of opposite charge, for example, a stainless-steel electrode. Applying the electrical potential result results in the electrocoating composition being deposited onto the conductive substrate. The resulting film may then be cured to obtain a substrate comprising an electrocoating. Suitable electrocoating materials include the electrocoating compositions described in EP0241476B1, EP0675926B1, EP0961797B1, EP1192226B1, WO2021/123106A1 and WO2021/239264A1, each of which is incorporated herein by reference.

Primer materials are typically used to form the first layer of a coating system applied to a substrate or an old coating. The primer materials may be solvent-borne or water-borne. The primer layer typically provides adhesion for the entire coating structure, i.e. not only the primer but also the subsequent layers. In addition, the primer layer may perform different tasks depending on the type of substrate, for example corrosion protection of metal substrates. Primer materials may comprise film-forming material(s), such as polyester, poly(meth)acrylic and epoxy resins. Primer materials may further comprise pigments. Primer materials may further comprise crosslinking agent(s), such as isocyanates and amine components. Primer materials may further comprise at least one adhesion promoter. Suitable primer materials are, for example, described in WO 2019081461 A1, WO 2020234066 A1, WO 2020233939 A1, WO 2021009252 A1, each of which is incorporated herein by reference.

Primer-surfacer materials are coating materials that combine the properties of primers and fillers. The primer-surfacer materials may be solvent-borne or water-borne. The primer-surfacer layer produced from the primer-surface materials may serve to protect against mechanical exposure such as stone chipping, for example, and also to level out unevennesses in the substrate. Primer-surfacer materials may comprise film-forming material(s), such as polyester resins, poly(meth)acrylic resins, epoxy resins and/or poly(meth)acrylic-epoxy resins. Primer-surfacer materials may further comprise pigments. Primer-surfacer materials may further comprise crosslinking agent(s), such as isocyanates and amine components.

Filler materials are typically used to form an intermediate coating layer within a multilayer coating. The filler materials may be solvent-borne or water-borne. The purpose of filler materials is to remove unevenness of the substrate, to support adhesion and corrosion protection (especially if they are used as primer-surfacer materials) as well as to provide good stone chipping resistance of the entire coating system. Filler materials may provide a good and fast sandability. Filler materials may be used wet-on-wet to cover fine sanding marks or smooth filler surfaces. Filler materials may comprise film-forming material(s), such as polyurethane-acrylate(s), polyurethane resins, epoxy resins, polyester resins, polyacrylate resins or a combination thereof. Filler materials may comprise crosslinking agent(s), such as isocyanates, blocked isocyanates or amines. Filler materials may comprise pigment(s). Suitable filler materials are, for example, described in WO 2020234066 A1, WO 2020233939 A1, each of which is incorporated herein by reference Putty materials may be highly pigmented coating materials used to level out substrate unevenness that is too large and can no longer be corrected by primer materials or filler materials (see also DIN 55945:1996-09). Putty materials may comprise film-forming material(s), such as unsaturated polyester resins or epoxy resins. Putty materials may comprise crosslinking agent(s), such as peroxides or amine components.

Basecoat materials may typically be used as color-imparting intermediate coating materials. The basecoat materials may be solvent-borne or water-borne. The basecoat materials may comprise at least one color pigment and/or at least one effect pigment. The basecoat layer resulting from the basecoat materials may be opaque, i.e. the underlying coating layers may no longer be visible through the basecoat layer. The basecoat materials may comprise film-forming material(s), such as poly(meth)acrylates, polyurethanes, polyesters, poly(meth)acrylate-polyurethanes, polyethers, melamine resins or combinations thereof. Suitable basecoat materials are, for example, disclosed in WO 2018177731 A1, WO 2018197163 A1, WO 2019020324 A1, US 20190031910 A1, WO 2019015953 A1, WO 2019207085 A1, WO 2019185306 A1, WO 2019211473 A1, WO 2020151977 A1, WO 2020136016 A1, WO 2020185946 A1, WO 2020216584 A1, WO 2021074187 A1, WO 2021074359 A1, WO 2021078923 A1, WO 2021094131 A1, WO 2021148255 A1, WO 2021191015 A1, WO 2021224232 A1, WO 2022063854 A1, EP 3957693 A1, each of which is incorporated herein by reference.

Clearcoat materials may typically be used as to produce a transparent coating with protective, decorative or specific technical properties (see also DIN EN 971-1: 1996-09). Clearcoat materials may not contain color/effect pigment(s) and/or filler(s). Clearcoat materials may contain transparent pigment(s). Clearcoat material(s) may be solvent-based, water-borne or solid materials. The transparent coating compositions preferably comprise at least one (first) polymer as a binder having functional groups, and at least one crosslinker having a functionality complementary to the functional groups of the binder. Preference is given to using at least one hydroxy-functional poly(meth)acrylate polymer as a binder and a polyisocyanate as a crosslinking agent. Suitable clearcoat materials are described, for example, in WO 2006/042585 A1, WO 2009/077182 A1 and WO 2008/074490 A1, each of which is incorporated herein by reference.

Tinted clearcoat materials may typically be used to produce a coating layer which is neither completely transparent and colorless as a clear coating nor completely opaque as a typical pigmented basecoat. A tinted clearcoat layer is therefore transparent and colored or semi-transparent and colored. The color may be achieved by adding small amounts of pigments commonly used in basecoat coating materials to clearcoat materials.

Hardener compositions may comprise at least one crosslinking agent. Suitable crosslinking agent(s) may be selected from melamine resin(s), polyisocyanate(s), blocked polyisocyanate(s), polycarbodiimide(s), amine(s) or combinations thereof. The hardener composition may comprise solvent(s), such as organic solvents and/or water.

Binder compositions may comprise at least one binder. The binder may correspond to the nonvolatile component of the dispersion, without pigments and fillers (see also DIN EN ISO 4618:2007-03). The binder may correspond to physically and/or chemically curable polymers, examples being polyurethanes, polyesters, polyethers, polyureas, polyacrylates, polysiloxanes and/or copolymers of the stated polymers. The polymer may comprise anionic, cationic and/or nonionic group(s). The binder may be dissolved or dispersed in a solvent. Binder dispersions may comprise water as solvent. The binder composition may comprise pigments, such as color and/or effect pigments. The binder composition may comprise a crosslinker, such as a blocked isocyanate. The binder composition may comprise additives commonly used in coating materials, such as the ones described later on. Suitable binder dispersions are described, for example, in EP3197961A1, EP1720923A1, EP3183304A1, WO2021018595A1, WO2021018594A1, US2011042222A1, EP2283087A1, WO2020233939A1, EP3423535A1, WO2020234066A1, WO2020234066A1, WO2016116299A1, WO2022189111A1, WO2015090442A1, each of which is incorporated herein by reference. Suitable binder solutions are described, for example, in WO 2006/042585 A1, WO 2009/077182 A1, WO 2008/074490 A1, WO2021018595A1, WO2021018594A1 and DE4110520A1, each of which is incorporated herein by reference.

Binder solutions may comprise at least one binder dissolved in a solvent. The binder may correspond to the nonvolatile component of the dispersion, without pigments and fillers (see also DIN EN ISO 4618:2007-03). The binder may correspond to physically and/or chemically curable polymers, examples being polyurethanes, polyesters, polyethers, polyureas, polyacrylates, polysiloxanes and/or copolymers of the stated polymers.

Pigment pastes may comprise pigment mixtures in carrier materials, namely different polymers. The concentration of pigments within the pigment paste is typically higher than the concentration of said pigments in a coating material prepared from said pigment paste. More particularly, in such pigment pastes, the weight ratio of pigments to polymers is generally greater than in coating compositions in which the paste is used. The pigment pastes may comprise water and/or organic solvents. The pigment pastes may comprise different additives, such as wetting agents and/or dispersing agents. The pigment pastes may be used to prepare colored coating materials, such as basecoat materials. The pigment pastes may be used within a mixer system to prepare colored coating materials used during the repair process. Suitable pigment pastes are, for example, disclosed in EP3083851A1, US10131808B2, EP3083836A1, WO2018172475A1, US2020140713A1, WO2021018595A1, WO2021018594A1, WO2022175076A1, WO2018019628A1, WO2021123106A1, US2007269606A1, WO2015070930A1 and WO2004018580A1, each of which is incorporated herein by reference. Additive compositions may comprise at least one additive. The additive may be selected from salts which can be broken down thermally without residue or substantially without residue, reactive diluents, transparent pigments, fillers, dyes soluble in a molecular dispersion, nanoparticles, light stabilizers, antioxidants, deaerating agents, emulsifiers, slip additives, polymerization inhibitors, initiators of free-radical polymerizations, adhesion promoters, flow control agents, film-forming assistants, sag control agents (SCAs), flame retardants, corrosion inhibitors, waxes, siccatives, biocides, and flatting agents, leveling agents, light stabilizers, such as UV absorber(s) or HALS, free-radical scavengers, slip additives, polymerization inhibitors, defoamers, wetting agents, flow control agents, film-forming assistants such as cellulose derivatives, rheology control additives, flame retardants and/or water scavengers, catalysts or a combination thereof. The additive composition may comprise a solvent, such as water or an organic solvent. The additive composition may comprise a binder, such as previously described. Thinners and reducers are typically used to adjust the viscosity of a coating material to a desired value or range. Thinners may contain solvent(s), such as organic solvents or water.

Reducers may contain solvent(s), such as organic solvents or water. The organic solvents may be selected from aliphatic or aromatic hydrocarbon such as Solvesso 100 (trademark), toluene or xylene, an alcohol such as butanol or isopropanol, an ester such as butyl acetate or ethyl acetate, a ketone such as methyl isobutyl ketone or methyl amyl ketone, an ether, an ether-alcohol or an ether-ester, or a mixture of any of these. Suitable reducers and thinners are described, for example, in WO2022200533A1 and WO2011068855A1, each of which is incorporated herein by reference.

Spot blender compositions may typically be applied over the uncured refinish clearcoat to produce “gentle” transition zones and to provide an “invisible” finish leaving no visual indications of repair at the damaged site. The spot blender compositions may comprise film-forming material(s), such as polyols, urethane(meth)acrylates or mixtures thereof. The spot blender compositions may comprise crosslinking agent(s), such as polyisocyanate(s), and may not comprise film-forming material(s), e.g. may be free of film-forming material(s). The spot blender composition may comprise a solvent, such as an organic solvent. The organic solvent may be selected from n-butyl acetate, isobutyl acetate, and xylene. Suitable spot blender compositions are described, for example, in US2010216945A1, WO2006097386A1, WO2006097385A1 and WO2007027286A2, each of which is incorporated herein by reference.

The chemical production network may include one or more one or more chemical and/or mechanical process(es). The chemical production network may produce one or more output material(s) through chemical and/or mechanical processing. The chemical production network may include multiple types of production processes for producing one or more output material(s) from one or more input material(s). The chemical production network may produce one or more output material(s) from input material(s) provided to the chemical production network. The chemical production network may include a complex production network producing multiple chemical products via multiple production process(es). The chemical production network may include connected, interconnected and/or non-connected production process(es). The chemical production network may include a composite or Verbund network.

The chemical production network may include identity preserving or segregated production process(es). Identity preserving or segregated in this context may refer to environmental attribute(s) of input material(s) being preserved or segregated in the production process(es). Examples are non-fossil, e.g. renewable or recycled, input materials used to produce the one or more coating material(s) without fossil content. Further examples are fossil input material(s) used to produce the one or coating material(s) with fossil content. Chemical production networks may include non-identity preserving or non-segregated production process(es). Non-identity preserving or non-segregated in this context may refer to non-fossil input material(s) being mixed with fossil input material(s) to produce the coating material(s). For example, fossil and renewable input materials may be mixed to produce the coating material(s) with fossil and renewable content.

The chemical production network may include one or more production process(es) with multiple production steps. The production steps included in the chemical network may be defined by the physical system boundary of the chemical production network. The system boundary may be defined by location and/or control over production processes or steps. The system boundary may be defined by a site of the chemical production network. The system boundary may be defined by production process(es) or step(s) controlled by one entity or multiple entities jointly. The system boundary may be defined by the value chain with staggered production process(es) or step(s) to the chemical end-product, which may be controlled by multiple entities jointly or separately. The chemical production network may include a waste collection, a sorting step, a recycling step such as pyrolysis, a cracking step such as steam cracking, a separation step to separate intermediates of one process step and further processing steps to convert such intermediates to output material(s), in particular the produced coating material(s), leaving the system boundary of the chemical production network. The input material(s) may enter the physical system boundary of the chemical production network. The entry point(s) of the chemical production network may be marked by the entry of input material(s) to the chemical production network or the system boundary of the chemical network. The output material(s), in particular the produced coating material(s), may leave the physical system boundary of the chemical production network. The exit point(s) of the chemical production network may be marked by the exit of output material(s), in particular the produced coating material(s), from the chemical production network or the system boundary of the chemical network.

The chemical production network may include one or more production chain(s) for the production of coating material(s). The production chain(s) for the production of coating material(s) may be interconnected. The production chain(s) for the production of coating material(s) may be interconnected with production chain(s) for the production of other output material(s). The production chain(s) for the production of coating material(s) may include production chain(s) for the production of intermediates used to produce coating material(s). The production chain(s) for the production of coating material(s) may use input material(s) provided by chemical network(s) for the production of intermediates usable to produce coating material(s).

One or more input material(s) may be provided to the chemical production network for one or more output material(s), in particular coating material(s). The output material(s), in particular coating material(s), may be produced from one or more input material(s) through one or more chemical process(s) of the chemical production network. The input material may comprise any input material entering the chemical production network at any entry point. The input material may include organic or inorganic input material(s). The input material may be a pre-cursor product, an intermediate material, a feedstock or a raw material used to produce one or more output material(s), in particular coating material(s). The input material may be fed to the chemical production network to produce one or more output material(s), in particular coating material(s). The input material may be fed to chemical production network including one or more production process(es) with multiple process steps. The input material may be fed to the chemical production network at the start of the production process or at any intermediate stage of the production process. The input materials entering the chemical production network may be used to produce one or more output material(s), in particular coating material(s).

The input material may be associated with an input material identifier. The input material identifier may comprise any identifier uniquely associated with the input material. The input material identifier may be associated with the physical entity of the input material. The input material identifier may be associated with a single batch of input material. The input material identifier may be associated with a group of input materials. The identifier may be associated with multiple physical entities of the input material. The input material identifier may be associated with continuous or semi-continuous stream of input material. The input material identifier may be associated with a stream of the input material e.g. over a certain time period or from a certain supplier. The input material identifier may be linked or connected to one or more environmental attribute(s).

Environmental attribute may refer to a property related to the environmental impact. Such property may be the property of input material(s), chemical process(es), chemical production network(s) and/or coating material(s). The environmental attribute may indicate an environmental performance of input material(s), chemical process(es), chemical production network(s) and/or coating material(s). The environmental attribute may be derived from properties of input material(s), chemical process(es), chemical production network(s) and/or coating material(s). The environmental attribute may be associated with the environmental impact of input material(s), chemical process(es), chemical production network(s) and/or coating material(s) at any stage of the lifecycle of the input material(s) and/or the coating material(s). The stages may include providing raw material, providing feedstock, producing chemical products, such as intermediate products or end products, producing discrete products by using the chemical products, using chemical products or discrete products, treating end-of-life products, recycling end-of-life products, disposing end-of-life products, reusing components from end-of-life products or any subset of stages. The environmental attribute may be specified or may be derived from any activity of one or more entities participating at any stage of the lifecycle of one or more material(s) or product(s).

The environmental attribute may include one or more characteristic(s) that are attributable to environmental impact of input material(s), chemical process(es), chemical production network(s) and/or the coating material(s). The environmental attribute may include environmental, technical, recyclability or circularity characteristics(s) associated with the environmental impact of input material(s), chemical process(es), chemical production network(s) and/or coating material(s).

The environmental attribute may include one or more characteristic(s) that are attributable to the environmental impact of input material(s), chemical process(es), chemical production network(s) and/or coating material(s). The environmental attribute may include environmental, technical, recyclability or circularity characteristics(s) associated with the environmental impact of input material(s), chemical process(es), chemical production network(s) and/or coating material(s). The one or more environmental attribute(s) may be attributable to the environmental impact of the coating material(s). The one or more environmental attribute(s) may relate to environmental, technical, recyclability, circularity and/or complementary risk characteristic(s) of the coating material(s).

Environmental characteristic(s) may specify or quantify ecological criteria associated with environmental impact. Environmental characteristic(s) may be or may be derived from measurements taken during the lifecycle. Environmental characteristics may be determined at any stage of the lifecycle and may characterize the environmental impact for such stage or up to such stage. Environmental characteristic(s) may for example include carbon footprint, greenhouse gas emissions, resource usage, air emissions, ozone depletion potential, water pollution, noise pollution, energy consumption, waste reduction, or eutrophication potential. Environmental characteristic(s) may for example include product characteristics related to the production of the product like bio based, vegetable based, animal based, halogen-free, fluorine-free, vegan, halal, kosher, palm oil-free, natural, tox-fee, isocyanate-free, melamine-free, volatile organic compounds-free or any combinations thereof.

Technical characteristic(s) may specify or quantify performance at least indirectly associated with the environmental impact. Technical characteristic(s) may be or may be derived from measurements taken during the lifecycle. Technical characteristics may be determined at any stage of the lifecycle and may characterize the performance for such stage or up to such stage. Technical characteristic(s) may for example include chemical composition data, raw material composition such as bio-based or recycled input material content specifying e.g. x % non-fossil and y % fossil content, bill of materials, product specification data such as product purity, product form (as indication to their impact on dust formation/release), safety data, product extractability, migration data, toxicological data or ecotoxicological data, product component data, safety data, application property data, application instructions, quality data or any combinations thereof.

Circularity characteristic(s) may specify or quantify the life cycle characteristics associated with circular uses. Circularity characteristic(s) may be or may be derived from measurements taken during the lifecycle. Circularity characteristic(s) may be or may be derived from circular data recorded in one or more prior lifecycle(s) including reuse. Circularity characteristic(s) may be determined at any stage of the lifecycle and may characterize the reuse or recycling performance for such stage or up to such stage. Circularity characteristic(s) may for example include recycling data, reuse rate, recycling rate, recycling loops, reuse performance, reused quality or any combinations thereof.

Recyclability characteristic(s) may specify or quantify life cycle characteristics associated with recycling uses. Recyclability characteristic(s) may include the composition of the material including specifically tailored constituents making the material suitable for recycling. Recyclability characteristic(s) may be or may be derived from measurements taken during the lifecycle. Recyclability characteristic(s) may be or may be derived from recycling data recorded in one or more prior lifecycle(s). Recyclability characteristics may be determined at any stage of the lifecycle and may characterize the recycling performance for such stage or up to such stage. Recyclability characteristic(s) may for example include recycling data, number of reuses, recyclate composition, recyclate quality, waste stream composition, waste stream quality or any combinations thereof.

In one embodiment the coating material passport or digital asset associated with the coating material(s) may include mass balanced environmental attributes related to the input material. Mass balanced environmental attributes may include environmental attributes of the input material(s) used to produce the coating material(s), which are tracked and by mass attributable to the coating material(s). The environmental impact of input material(s) may be determined based on input material(s) used in the chemical process(s) to produce the coating material(s). For example, bio-based, renewable and/or recycled content of input material(s) used to produce the coating material(s) may be tracked. Further for example, properties of the chemical process(es) used to produce the coating material(s) may be tracked. Examples of tracked process properties related to the environmental impact include water consumption, CO₂ emissions and/or Greenhouse Gas (GHG) emissions, amount of waste generation, mixed material generation, design for recycling, energy consumption, processing properties such as less waste or less loss of properties. The properties may be tracked based on a certificate from a certifying agency. The properties may be tracked based on inherent physical properties derived from measurements.

In one embodiment the produced coating material(s) is/are connected to the decentral identifier physically identifying the produced coating material(s). The production operating apparatus may be configured to provide the decentral identifier associated with a physical entity of the produced coating material(s). The production operating apparatus may be configured to link the decentral identifier to a physical identifier of the produced coating material(s). The production operating apparatus may be configured to assign the decentral identifier to the physical identifier connected to the produced coating material(s). The production operating apparatus may be configured to assign the decentral identifier to the physical identifier physically connected to the produced coating material(s).

In one embodiment the decentral identifier relates to data associated with at least one product produced from the coating material(s), wherein the one or more environmental attribute(s) associated with the at least one product is derived from one or more environmental attribute(s) associated with the coating material(s). The one or more environmental attribute(s) associated with the coating material(s) may be associated with the one or more input material(s) and/or the chemical process(es) used to produce the coating material(s). The decentral identifier may relate to any identifier uniquely associated with the coating material(s). The decentral identifier may be associated with the physical entity of the coating material(s). The decentral identifier may refer to a single batch of the produced coating material(s). The decentral identifier may be associated with a group of coating material(s). The identifier may refer to multiple physical entities of the produced coating material(s). The decentral identifier may be associated with continuous or semi-continuous stream of coating material(s). The identifier may refer to a stream of the coating material(s) e.g. over a certain time period or from a certain supplier.

In one embodiment the one or more environmental attribute(s) associated with the coating material(s) are provided from at least one balancing account configured to store environmental attribute(s) associated with input material(s). The balancing account may relate to storage structure associated with metadata, such as an environmental attribute type. For instance, the balancing account may be associated with metadata indicating the environmental attribute type to be recycled-content or bio-based. An inbound allocator may be configured to allocate the one or more environmental attribute(s) associated with input material(s) to at least one balancing account e.g. on entry of the input material to the chemical production network. The balancing account may be associated with the respective environmental attribute type. An outbound assigner may be configured to assign at least one environmental attribute from the at least one balancing account associated with the respective environmental attribute to the decentral identifier. One or more environmental attribute(s) may be assigned to the at least one decentral identifier. Assignment may include de-allocation of the one or more environmental attributes from the balancing account associated with the respective environmental attribute type. By using the balancing accounts environmental attributes of input materials can be reliably tracked and assigned to produced coating material(s).

An inbound allocator may be configured to allocate the one or more environmental attribute(s) to at least one balancing account associated with the respective environmental attribute, e.g. on input material entering the chemical production network. The balancing account may be associated with the respective environmental attribute type. The one or more environmental attribute(s) associated with the input materials may be allocated to the balancing account associated with the respective environmental attribute type. An outbound assigner may be configured to assign or link at least one environmental attribute from the at least one balancing account associated with the respective environmental attribute type to the decentral identifier. This may include de-allocation of the one or more environmental attribute(es) from the balancing account associated with the respective environmental attribute type. By using the balancing accounts environmental attributes can be tacked through the chemical production network. This way the environmental attributes may be detached from the material flow. Attribution of environmental attribute(s) may be conducted on a mass balance basis for the chemical production network. In such approach the total mass of input materials and produced coating material(s) as well as the attribution of respective environmental attribute(s) associated with input materials and produced coating material(s) are balanced.

In one embodiment the one or more environmental attribute(s) are associated with at least one property related to the environmental impact of the one or more input material(s) and/or the chemical process(es). The one or more environmental attribute(s) may specify environmental properties of the input material(s) used to produce the coating material(s) and/or the one or more environmental attribute(s) may specify environmental properties of the chemical process(es) used to produce the coating material(s). The one or more environmental attribute(s) may be generated from environmental properties of the input material(s) used to produce the coating material(s), process data associated with the chemical processing of the input material(s) and/or energy data associated with the energy consumption of the chemical processing. The one or more environmental attribute(s) may include a recycled content associated with the input material(s) and allocated or allocatable to the produced coating material(s), a renewable content associated with the input material(s) and allocated or allocatable to the produced coating material(s), and/or a product carbon footprint associated with the produced coating material(s).

In one embodiment the production operating apparatus is configured to gather environmental attributes associated with the produced coating material(s) before, during and/or after production of the coating material(s) by the chemical production network. The environmental attributes associated with the produced coating material(s) may relate to input material(s). The environmental attributes associated with input materials may be provided before, during and/or after production of the coating material(s) by the chemical production network. The environmental attributes associated with input materials may be allocated to at least one balancing account before, during and/or after production of the coating material(s) by the chemical production network. The environmental attributes associated with the produced coating material(s) may relate to environmental properties generated from process data associated with the chemical processing of the input material(s) and/or energy data associated with the energy consumption of the chemical processing. The environmental attributes associated with the produced coating material(s) may be generated before, during and/or after production of the coating material(s) by the chemical production network. The process data associated with the chemical processing of the input material(s) and/or energy data associated with the energy consumption of the chemical processing may be gathered prior, during and/or after production of the coating material(s).

In one embodiment the coating material passport or the digital asset may include the decentral identifier associated with the coating material and the one or more environmental attribute(s) linked to the decentral identifier. The one or more environmental attribute(s) may be linked to the decentral identifier included in the coating material passport or the digital asset. The one or more environmental attribute(s) may be stored in a data base associated with or of the coating material(s) producer for access by any consumer of the produced coating material(s). The one or more environmental attribute(s) may be stored in a data base associated with or of the coating material(s) producer for transfer to a consumer of the produced coating material(s) e.g. when accessed or on providing the coating material(s). The decentral identifier may comprise any unique identifier uniquely associated with the coating material(s) producer and coating material data such as the environmental attributes. The decentral identifier may include one or more Universally Unique Identifier(s) (UUID(s)) or a Digital Identifier(s) (DID(s)). The decentral identifier may be issued by a central or decentral identity issuer. The decentral identifier may be linked to authentication and/or authorization information. Via the decentral identifier and its unique association with the coating material(s) producer and coating material data, such as the environmental attributes, access to the coating material data may be controlled by the coating material(s) producer. This contrasts with central authority schemes, where identifiers are provided by such central authority and access to data is controlled by such central authority. Decentral in this context refers to the usage of the identifier in implementation as controlled by the data owner, such as the coating material(s) producer.

The decentral identifier may be uniquely associated with the coating material or the physical entity of the coating material, e.g. as packaged for transportation to the consumer of the coating material. The decentral identifier may be uniquely to the one or more environmental attribute(s). The coating material passport or the digital asset may include one or more digital representation(s) pointing to coating material data including the environmental attribute(s) or parts thereof including the environmental attribute(s). The digital representation may comprise at least one interface to a data providing service. It may further include at least one interface to a data consuming service. It may include an endpoint for data exchange or sharing (resource endpoint) or an endpoint for service interaction (service endpoint), that is uniquely identified via a communication protocol. The digital representation(s) pointing to coating material data or parts thereof may be uniquely associated with the decentral identifier.

The coating material passport or the digital asset may comprise or be connected to a digital representation of coating material data, such as environmental attribute(s). The digital representation may include a representation for accessing the coating material data, such as environmental attribute(s) or part thereof. The digital representation may include a representation of coating material data, such as environmental attribute(s). The coating material passport or the digital asset may include or be connected to data related to the coating material data, such as environmental attribute(s), the authentication information and the decentral identifier. The data related to the coating material data, such as environmental attribute(s), may include the digital representation of the coating material data, such as environmental attribute(s).

### BRIEF DESCRIPTION OF THE DRAWINGS

In the following, the present disclosure is further described with reference to the enclosed figures:

FIG. 1 illustrates schematically an example of a chemical production network producing one or more output material(s) from one or more input material(s) in connection with a production operating system including an attribute management system.

FIG. 2 illustrates schematically an example of attributing environmental attributes of input materials to output materials of the chemical production network.

FIG. 3 illustrates schematically an example of attributing environmental attributes of input materials and chemical processes to an output material of the chemical production network.

FIG. 4 illustrates schematically another example of a method or apparatus for providing environmental attributes associated with output materials to a material user as data consumer via a decentral network.

FIG. 5 illustrates schematically an example of a method or apparatus for providing environmental attributes of output materials across value chains via the decentral network.

FIG. 6A illustrates schematically an example of a chemical production network for producing a coating material associated with a coating material passport or digital asset.

FIG. 6B illustrates schematically an example of a chemical production network for producing a hardener component and/or a binder solution associated with a coating material passport or digital asset.

FIG. 6C illustrates schematically an example of a chemical production network for producing a binder dispersion associated with a coating material passport or digital asset.

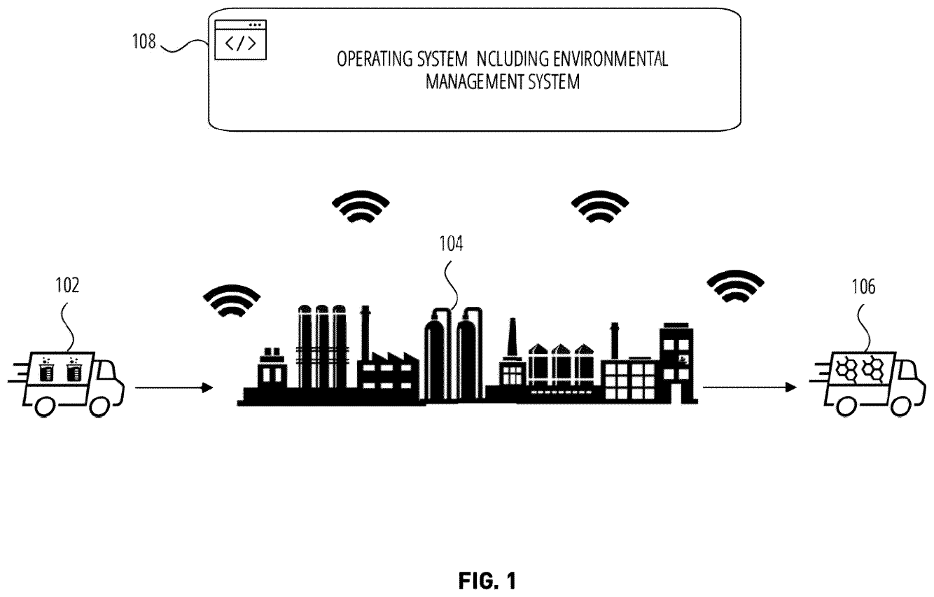

FIG. 1 illustrates an example of a chemical production network 104 producing one or more output material(s), in particular coating material(s), 106 from one or more input material(s) 102 in connection with a production operating system 108 including an attribute management system. The coating material may be selected from coating material(s) or a coating material component. The coating material may be selected from electrocoating materials, primer materials, primer-surfacer materials, filler materials, putty materials, basecoat materials, clearcoat materials or tinted clearcoat materials. For instance, the coating material may be a primer material. In another instance, the coating material may be an electrocoating material. In yet another instance, the coating material may be a clearcoat material. The coating material component may be selected from hardener compositions, additive compositions, thinners, reducers, mixing clears, spot blender compositions, pigment pastes or binder compositions. For instance, the coating material component may be a hardener composition. In another instance, the coating material component may be binder compositions. In yet another instance, the coating material component may be a thinner. In yet another instance, the coating material component may be a reducer. In yet another instance, the coating material component may be a mixing clear. In yet another instance, the coating material component may be a spot blender composition. In yet another instance, the coating material component may be a pigment paste. In yet another instance, the coating material component may be an additive composition.

For producing one or more output material(s), in particular coating material(s), 106 different input materials 102 may be provided as physical inputs to the chemical production network 104. The physical input material(s) 102 and output material(s), in particular coating material(s), 106 may be associated with one or more properties related to environmental impact. The properties related to environmental impact may be digitalized in the form of environmental attributes such as recycled or bio-based content of the input materials. The production operating system 108 may be configured to ingest such environmental attributes and to track the environmental attributes across the chemical production network 104 from input materials 102 to output material(s), in particular coating material(s), 106.

The chemical production network 104 may include multiple interlinked processing steps. The chemical production network 104 may be an integrated chemical production network 104 with interrelated production chains. The chemical production network 104 may include multiple different production chains that have at least one intermediate product in common. The chemical production network 104 may include multiple stages of the chemical value chain. The chemical production network 104 may include the producing, refining, processing and/or purification of gas or crude oil. The chemical production network 104 may include a stream cracker, or a syngas plant connected to multiple production chains that output products 104 from the effluent of such plants. The chemical production network 104 may include multiple production chains that output from one or more input material(s) 104 one or more output material(s), in particular coating material(s), 106. The chemical production network 104 may include multiple tiers of a chemical value chain. The chemical production network 104 may include a physically interconnected arrangement of production sites. The production sites may be at the same location or at different locations. In the latter case the production sites may be interconnected by means of dedicated transportation systems such as pipelines, supply chain vehicles, like trucks, supply chain ships or other cargo transportation means.

The chemical production network 104 may chemically convert input materials 102 to one or more output material(s), in particular coating material(s), 106. The chemical production network 104 may convert input materials 102 by way of chemical conversion to one or more output material(s), in particular coating material(s), 106.

The input materials 102 may be fed to the chemical production network 104 at any entry point. The input materials 102 may be fed to the chemical production network 104 at the start of the chemical production network 102. Input materials 102 may for example make up the feedstock of a steam cracker. The input material 102 may include non-fossil input material, such as bio-based or recycled material, and/or fossil input material for the manufacture of chemical intermediates and chemical output material(s), in particular coating material(s), 106.

The chemical production network 104 may include multiple production steps. The production steps included in the chemical production network 104 may be defined by the system boundary of the chemical production network 104. The system boundary may be defined by location or control over production processes. The system boundary may be defined by the site of the chemical production network 104. The system boundary may be defined by production processes controlled by one entity or multiple entities jointly. The system boundary may be defined by value chain with staggered production processes to an end product, which may be controlled by multiple entities separately. The chemical production network 104 may include a waste collection and sorting step, a recycling step such as pyrolysis, a cracking step such as steam cracking, a separation step to separate intermediates of one process step and further processing steps to convert such intermediates to output material(s), in particular coating material(s), 106 leaving the system boundary of the chemical production network 104.

The production operating system 108 of the chemical production network 104 may be configured to monitor and/or control the chemical production network 104 based on operating parameters of the different processes. One process step monitored and/or controlled may be the feed of input materials 102 or the release of output material(s), in particular coating material(s), 106. Another process step monitored and/or controlled may be the registration of environmental attributes associated with input materials 102 entering the system boundary of the chemical production network 104. Yet another process step monitored and/or controlled may be the attribution of environmental attributes to output material(s), in particular coating material(s), 106 produced via the chemical production network 102. Yet another process step monitored and/or controlled may be the management of environmental attributes associated with input materials 102 and output material(s), in particular coating material(s), 106 of the chemical production network 104.

The production operating system 108 may be configured to register inbound environmental attributes and to assign outbound environmental attributes. The production operating system 108 may be configured to access data related the inputs materials 102, the processes and/or the output material(s), in particular coating material(s), 106 used in the chemical production network 104. For example, the production operating system 108 may be configured to register a recycled or bio-based content of the one or more input material(s) 102 used in the chemical production network 104 as environmental attribute. The production operating system 108 may be configured to allocate the environmental attribute to at least one balancing account associated with the recycled or bio-based content of the input materials 102. The production operating system 108 may be configured to allocate at least a part of the environmental attributes from the at least one balancing account to the at least one output material(s), in particular to the coating material(s), 106.

The production operating system 108 may be configured to handle environmental attributes related to the input materials 102 and output material(s), in coating material(s), 106 of the chemical production network 104. For example, the production operating system 108 may be configured to determine environmental attributes associated with the use of input materials 102 impacting the environmental property of the chemical production network 104 and the output material(s), in particular coating material(s), 106 produced by the chemical production network 104. Further in particular, the production operating system 108 may be configured to determine environmental attributes associated with the output material(s), in particular coating material(s), 106. This way the production operating system 108 may be configured to store environmental attributes in balancing accounts or to withdraw environmental attributes from the balancing accounts. The environmental attributes may hence be viewed as a credit that may be deposited in an account or deducted from an account related to the input and output material(s), in particular coating material(s), 106 of the chemical production network 104. This way the environmental impact of the production may be tracked and/or traced.

In chemical production networks 104, multiple value chains may be linked. Additionally different input materials 102 or chemical processes impacting the environmental property of output material(s), in particular coating material(s), 106 produced by the chemical production network 104 may be used. Examples of input materials 102 impacting at least one environmental property of output material(s), in particular coating material(s), 106 produced from such input materials 102 are recycled, renewable or bio-based input materials 102. Examples of chemical processes impacting the environmental property include chemical processes using environmentally friendly technology such as carbon capture, carbon utilization, heat pumps or energy produced from natural sources, such as the sun or wind.

Owing to the processing of chemicals in continuous or semi-continuous production and the complexity of chemical production networks 104, traceability of the input materials 102 through the network may be hampered. In such scenarios, an equivalent environmental attribute signifying the impact on the environmental property of output material(s), in particular coating material(s), 106 produced by the chemical production network 108 may be allocated to balancing accounts and assigned to one or more output material(s), in particular coating material(s), 106 of the chemical production network 104. The environmental attributes may hence be decoupled from the physical material flow inside the chemical production network 104. Decoupling may be based on the mass balance model in that the equivalent amount assigned to the one or more output material(s), in coating material(s), 106 may not exceed the equivalent amount provided by input materials 102 or processes. If an equivalent amount has been allocated to the virtual account of one environmental attribute type, it may not be allocated a second time to another virtual account of the one environmental attribute type. Environmental attribute types may be recycled, bio-based, renewable or the like. Environmental attributes may be provided in the form of digital assets or coating material passports attached to the physical entity of the coating material.

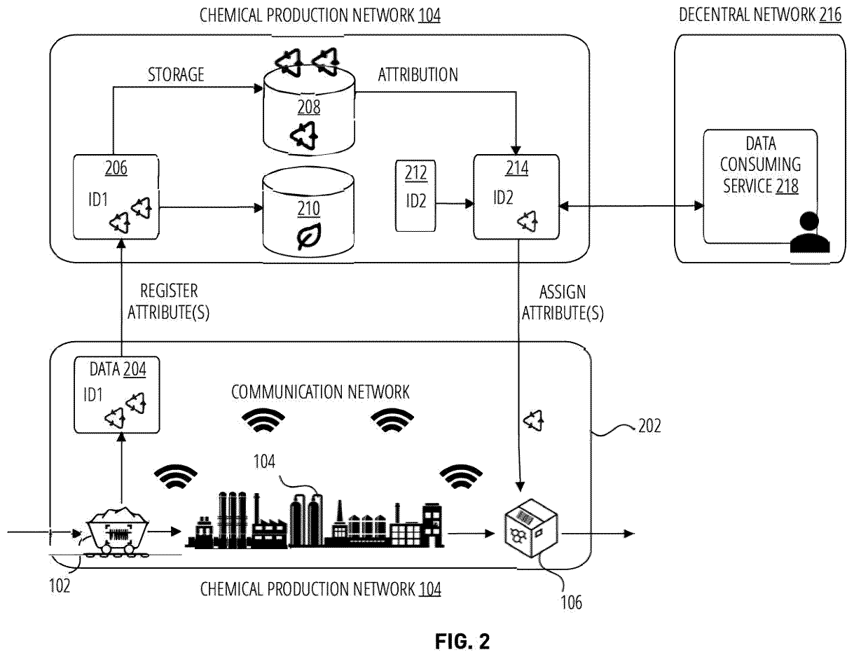

FIG. 2 illustrates schematically an example of attributing environmental attributes associated with input materials 102 to output material(s), in particular coating material(s), 106 of the chemical production network 104. The chemical production network 104 comprises a physical system boundary 202. The physical system boundary 202 may be defined as previously described.

As shown in FIG. 1 the chemical production network 104 and operations of the chemical production network 104 may be monitored and/or controlled by a production operating system 108. The production operating system 108 may be configured to track environmental attributes from input materials 102 fed to the chemical production network 104 to output material(s), in particular coating material(s), 106 produced by the chemical production network 104. For tracking, the operating system 108 may be configured to register environmental attributes associated with the input materials 102 provided to the chemical production network 104 and to attribute environmental attributes to output material(s), in particular coating material(s), 106 produced by the chemical production network 104.

The input materials 102 such as oil, natural gas, pyrolysis oil, bio-naphtha and biomethane may be provided to the chemical production network 104. The input materials 102 may enter the chemical production network 104 at the entry point, such as a such as a steam cracker or a syngas plant. The input materials 102 may be used in the chemical production network 104 to produce one or more output material(s), in particular coating material(s), 106 from the input materials 102. Output material(s), in particular coating material(s), 106 may be provided at exit points of the chemical production network 104. Output material(s) may be coating material(s). The coating material(s) may be selected from the group consisting of electrocoating materials, primer materials, primer-surfacer materials, filler materials, putty materials, basecoat materials, clearcoat materials or tinted clearcoat materials. For instance, the coating material may be a primer material. In another instance, the coating material may be an electrocoating material. In yet another instance, the coating material may be a clearcoat material. Output material(s) may be coating material component(s). The coating material component(s) may be selected from the group consisting of hardener compositions, additive compositions, thinners, reducers, mixing clears, spot blender compositions, pigment pastes or binder compositions. For instance, the coating material component may be a hardener composition. For instance, the coating material component may be a hardener composition. In another instance, the coating material component may be a binder composition. In yet another instance, the coating material component may be a thinner. In yet another instance, the coating material component may be a reducer. In yet another instance, the coating material component may be a mixing clear. In yet another instance, the coating material component may be a spot blender composition. In yet another instance, the coating material component may be a pigment paste. In yet another instance, the coating material component may be an additive composition.

On entry of the input material 102, input material data 204 may be provided via a communication network to a computing interface of the production operating system 108. A data provider, such as a QR code reader, may be configured to provide material data 108 related to the one or more input material(s) 102 and respective environmental attributes 108 to a computing interface configured to allocate the environmental attributes associated with the input materials 102. The material data 108 may include the input material identifier and environmental attributes associated with the input materials 102. The input material identifier may be associated with the physical entity of the input material 102 entering the chemical production network 104. The material data may be provided on, prior or after providing of the one or more input material(s) at entry points to the chemical production network 104.

The input material identifier may be linked to the environmental attribute(s) associated with the respective input material(s) 102, the amount of input material 102 and the certificate certifying the environmental attribute(s). The amount of input material may be a measured amount of input material 102 fed to a plant or storage of the chemical production network 104 for producing one or more output material(s), in particular coating material(s), 106 from the input material(s) 102. The input material identifier associated with the respective input material 102, the environmental attribute(s) associated with the respective input material(s) 102 and the amount of input material(s) 102 provided to the chemical production network 104 may be provided to the production operating system 108. Such data may be provided via a communication network on entry to chemical production network 104, or the data may be transferred from a computing system to the production operating system 108.

An inbound allocator 204 may be configured to allocate the one or more environmental attribute(s) to at least one balancing account 208 associated with the respective environmental attribute. For example, one balancing account 208 may relate to environmental attributes from bio-based material and another balancing account 210 may relate to environmental attributes from recycled material. The balancing account may be associated with the respective environmental attribute type, such as bio-based or recycled. Based on such association the balancing account associated with the environmental attribute type of the respective input material 102 may be selected. The environmental attributes may be allocated to the selected balancing account. For example, the balancing account 208 for recycled material may be selected and the environmental attribute may be allocated to such account 208.

To allocate, the one or more environmental attribute(s) may be converted to balancing units and the balancing units may be allocated to the balancing account 208. The conversion may be based on a conversion factor such as mass, weight, carbon atoms, hydrogen atoms, methane equivalents or any other suitable measure for quantifying the environmental impact of the environmental attribute. The conversion factor may hence consider the difference between producing chemical products from conventional input material(s) and producing chemical products from non-conventional input material(s) or producing chemical products from a mix of conventional and non-conventional input materials. The conversion factor may relate to differences in chemical and/or physical properties of conventional and non-conventional input material(s).

By using the balancing accounts 208 it can be ensured that environmental attributes of input materials 102 are only used once for assignment to coating material(s) 106. This way double counting on input or output is avoided to ensure that positive environmental impact can be reliable tracked and assigned to coating material(s) 106.

An identifier provider 212 may be configured to provide the coating material identifier (ID2) associated with the coating material produced by the chemical production network 104 and provided at the exit point from the chemical production network 104.

An outbound assigner 214 may be configured to assign at least one environmental attribute from the at least one balancing account 208 associated with the respective environmental attribute to the coating material identifier ID2. One or more environmental attribute(s) may be assigned to the at least one coating material identifier ID2. Assignment may include de-allocation of the one or more environmental attributes from the balancing account 208 associated with the respective environmental attribute type. Assignment may include converting one or more balancing unit(s) to one or more environmental attribute(s).

Assigning at least one environmental attribute associated with input material(s) to machinal fluid(s) may include the linking of the coating material identifier ID2 with the environmental attribute. The coating material identifier ID2 may be associated with the physical entity of the coating material. This way the virtual identifier of the material, such as the coating material, may be uniquely linked to the physical material. Such linking may include a physical or virtual link of identifiers uniquely associated with the physical material. For physical linking a tag or code may be physically connected to the material, e.g., by printing a QR code on the packaging or by embossing a code into the material. For virtual linking, different identifiers associated with the physical material may be linked. For example, an order number, a batch number, LOT number or a combination thereof may be linked.

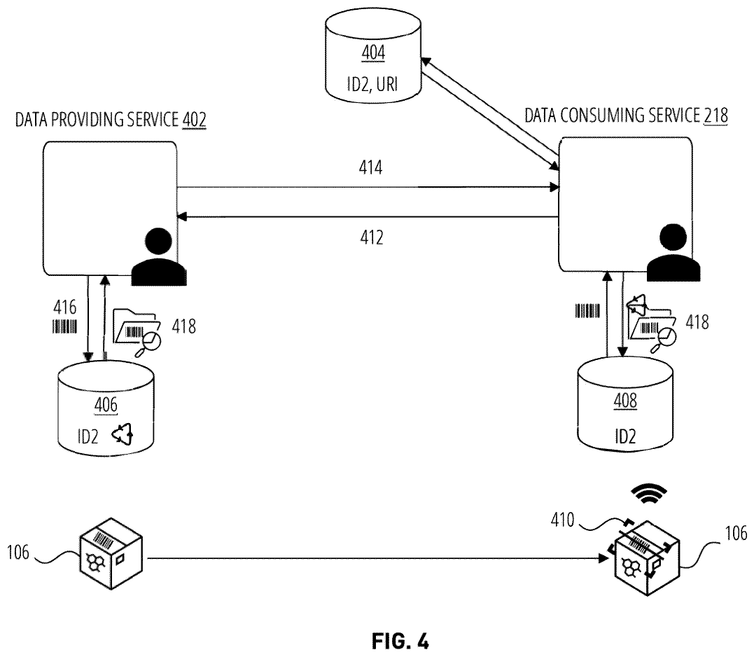

The outbound assigner 214 may be configured to provide the environmental attributes associated with the coating material(s) to a data consumer, such as a data consuming service 218, associated with a consumer of the coating material(s). The outbound assigner 214 may be configured to provide the environmental attributes associated with the coating material(s) to a decentral network, such as decentral network 216, as will be described in the example of FIG. 4. Environmental attributes may be provided via the above ID based schema in the form of digital assets or coating material passports associated with the physical entity of the coating material.

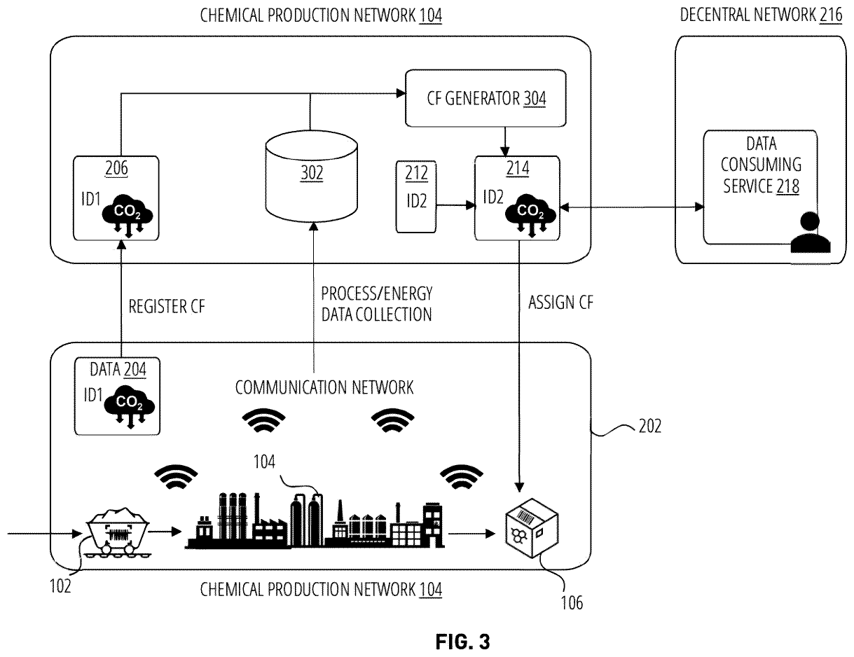

FIG. 3 illustrates schematically an example of attributing environmental attributes of input materials 102 and chemical processes to the coating material(s) 106 produced by the chemical production network 102. The chemical production network 104 comprises a physical system boundary 202. The physical system boundary 202 may be defined as previously described.

As described in the context of FIGS. 1 and 2 the chemical production network 104 and operations of the chemical production network 104 may be monitored and/or controlled by a production operating system 108. Input materials 102 such as oil, natural gas, pyrolysis oil, bio-naphtha and/or biomethane may be provided to the chemical production network 104. The input materials 102 may be used in the chemical production network 104 to produce one or more coating material(s) 106 from the input materials 102.

On entry of the input material 102, input material data 204 may be provided via a communication network to a computing interface of the production operating system 108. A data provider, such as a QR code reader, may be configured to provide input material data 204 related to the one or more input material(s) 102 and respective environmental attributes to a computing interface configured to allocate the environmental attributes associated with the input materials 102. The input material data 204 may include the input material identifier and environmental attributes associated with the input materials 102. The input material identifier may be associated with the physical entity of the input material 102 entering the chemical production network 104. The input material identifier may be linked to the carbon footprint of the input material 102 as environmental attribute. The material data may be provided on, prior or after providing of the one or more input material(s) at entry points to the chemical production network 104.

The inbound allocator 206 may be configured to retrieve the one or more environmental attribute(s) and to provide such attributes to the carbon footprint (CF) generator 304. A process data provider 302 may be configured to gather process data associated with the chemical processing of the input material(s) 102 to produce the coating material(s) 106. The process data provider 302 may be configured to gather energy data associated with the energy consumption of the chemical processing. The process data provider 302 may be configured to provide the process data and the energy data to the CF generator 304.

The CF generator 304 may be configured to determine the carbon footprint of the coating material(s) produced by the chemical production network. The carbon footprint of the of the coating material(s) may be determined based on the process data, the energy data and the carbon footprint of the input material(s) 102 used to produce the coating material(s).

An identifier provider 212 may be configured to provide the coating material identifier associated with the coating material produced by the chemical production network 104 and provided at the exit point from the chemical production network 104.

An outbound assigner 214 may be configured to assign the determined carbon footprint to the coating material identifier ID2. One or more environmental attribute(s) may be assigned to the at least one coating material identifier ID2, such as described in the context of FIG. 2.

The outbound assigner 214 may be configured to provide the environmental attributes, in particular the carbon footprint, associated with the produced coating material(s) to a data consumer, such as a data consuming service 218, associated with a consumer of the coating material(s). The outbound assigner 214 may be configured to provide the environmental attributes associated with the coating material(s) to a decentral network, such as decentral network 216, as will be described in the example of FIG. 4. Environmental attributes may be provided via the above ID based schema in the form of digital assets or coating material passports associated with the physical entity of the coating material.

FIG. 4 illustrates schematically an example of a method or apparatus for providing environmental attributes associated with coating material(s) to a material consumer as data consumer via a decentral network.

The coating material(s) 106 as produced by the chemical production network 104 may be provided in association with the digital asset as described in the context of FIGS. 2 and 3. The digital asset may include the coating material identifier. The digital asset may include one or more environmental attribute(s) such as the product carbon footprint, recycled content or bio-based content. The digital asset may relate to one or more environmental attribute(s) such as the product carbon footprint, recycled content or bio-based content. The digital asset may include a digital representation of one or more environmental attribute(s) such as the product carbon footprint, recycled content or bio-based content.

The digital asset may further include or relate to authentication and/or authorization information linked to coating material identifier. The authentication and/or authorization information may be provided for authentication and/or authorization of a data providing service 402 and/or data consuming service 218. The coating material identifier may include or relate to a decentral identifier, that is uniquely associated with the coating material. The decentral identifier may be connected to the digital representation of the environmental attributes. The digital representation may include a representation for accessing the environmental attributes or parts thereof. The decentral identifier may include one or more Universally Unique Identifier(s) (UUID(s)) or Digital Identifier(s) (DID(s)). The decentral identifier may include any unique identifier uniquely associated with a data owner and/or the coating material. The data owner may be the producer of the coating material(s). Via the decentral identifier and its unique association with the data owner and/or the coating material(s), access to the material configuration data may be controlled by the data owner.

The digital asset including the digital representation of one or more environmental attribute(s) such as the product carbon footprint, recycled content or bio-based content may be stored in a decentral data base 404. The one or more environmental attribute(s) such as the product carbon footprint, recycled content or bio-based content may be stored in a data base 406 associated with the data owner, such as the producer of the coating material(s) 106.

The coating material(s) 106 may be physically delivered to a consumer of the coating material(s). The coating material may be connected with a QR-code or having embossed a code having encoded the coating material identifier. The consumer of the coating material may read the code through a code reader, such as a QR-code reader, 410. The coating material identifier may be provided to a data base 408 associated with the consumer of the coating material 106.

In other embodiments the consumer of the coating material may retrieve the coating material identifier through the decentral data base 404.

The data owner in this example may be the input material producer, the output material producer, the output material user, the end product producer. The data owner may comprise any entity generating data. The data generating node may be coupled to the data owner or the entity owning or producing physical products from or for which data is generated. The data may be generated by a third-party entity on behalf of the entity owning physical products from or for which data is generated.

The data consuming service 218 may comprise computer-executable instructions for accessing and/or processing data, such as coating material data, associated with the data owner. The data providing service 402 may comprise computer-executable instructions for providing and/or processing data, such as coating material data, associated with the data owner for accessing and/or processing by the data consuming service 218.

Based on the received coating material identifier a request to access the environmental attributes associated with the coating material identifier may be triggered by the data consuming service 218 as signified by arrow 412. The coating material identifier may be provided to the data providing service 402 associated with or of the producer of the coating material. In addition, authentication and/or authorization information may be provided.

The request may be authenticated and/or authorized to access the environmental attributes associated with the coating material identifier. Based on successful authorization and/or authentication, access to the environmental attributes associated with the coating material identifier may be granted.

For access, the coating material identifier may be provided to the data providing service 402 as signified by arrow 412. The data providing service 402 may use the received coating material identifier to retrieve the environmental attributes associated with the received coating material identifier as signified by arrows 416 and 418. The retrieved environmental attributes associated with received coating material identifier may be provided to the data consuming service 218 as signified by arrow 414. The environmental attributes associated with the coating material 106 may be stored in the data base 408 associated with the consumer of the coating material 106 as signified by arrow 418.

Through the output identifier or decentral identifier, the environmental attributes can be uniquely associated with the coating material. Through the decentral network the environmental attributes may be transferred between the producer of the coating material and the consumer of the coating material. This way the environmental attributes can be shared with unique association to the coating material and without central intermediary directly between the value chain players. This allows for transparency of environmental attributes across the value chain and positive environmental impacts from coating material(s) produced by the chemical production network 104 can be tracked through the value chain.

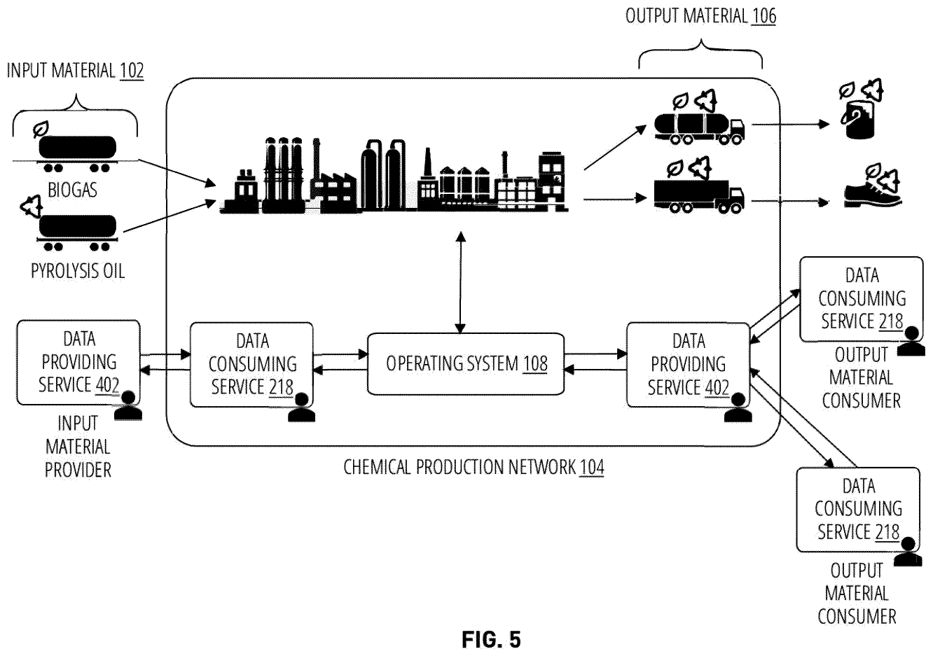

FIG. 5 illustrates schematically an example of a method or apparatus for providing environmental attributes associated with coating material(s) across value chains via the decentral network.

In the example of FIG. 5 a fully connected value chain including the chemical production network 104 is illustrated. In the example, the input material provider, the coating material producer, the coating material consumer and the end product producer may be connected to the decentral network as described in the context of FIG. 4. Environmental attributes may be provided via the ID based schema described in the context of FIGS. 2 to 4 in the form of coating material passports or digital assets associated with the physical entity of the input material, the coating material, any intermediate product or the end product.

The input material provider may provide the input material 102. The input material 102 may include bio-based input material or recycled material. The environmental attributes of said input material 102 may be provided through the data providing service connected to the decentral network as described in the context of FIG. 4. The coating material producer may produce the coating material from the input material(s) 506 provided to the chemical production network 104. The coating material producer may access the environmental attributes associated with the input material 102 through a data consuming service 218 connected to the decentral network as described in the context of FIG. 4. Said environmental attributes may be retrieved from a data providing service 402 associated with the respective input material provider. The coating material producer may manage the environmental attributes via the production operating system 108 as described in the context of FIGS. 1 to 3. The coating material producer may assign the environmental attributes associated with the input materials 102 or environmental attributes associated with the chemical production network 104 such as the carbon footprint, to the produced coating material(s) 106 as described in the context of FIGS. 1 to 3. The coating material producer may provide the environmental attributes associated with the produced coating material(s) 106 through the data providing service 402 connected to the decentral network as described in the context of FIG. 4. The coating material consumer or the end product producer may access the environmental attributes associated with the produced coating material(s) 106 through the data consuming service 218 connected to the decentral network as described in the context of FIG. 4.

The respective data owners in this example may be the input material producer, the output material producer, the output material consumer, the end product producer. The data owner may comprise any entity generating data. The data generating node may be coupled to the data owner or the entity owning or producing physical products from or for which data is generated. The data may be generated by a third-party entity on behalf of the entity owning physical products from or for which data is generated.

The data consuming service 218 may comprise computer-executable instructions for accessing and/or processing data, such as coating material data, associated with the data owner. The data providing service 402 may comprise computer-executable instructions for providing and/or processing data, such as coating material data, associated with the data owner for accessing and/or processing by the data consuming service.

In the example of FIG. 5 the decentral identifier may relate to the end product. Such decentral identifier may be provided to the value chain participants. Via the end product specific decentral identifier data associated with the end product produced from the coating material may be gathered across the production chain and assigned to the end product specific decentral identifier. For example, the one or more environmental attribute(s) associated with the end product may be derived from the environmental attribute(s) associated with the coating material, the input material 102 or any other product entity present in the value chain of the end product.

This way the environmental attributes of input materials 102, produced coating material(s) 106 and any products produced from said coating material(s) may be tracked through the value chain up to the end product. By tracking the environmental attributes of materials in such way the information can be made transparent across the value chain while the information flow can be controlled by the participants in the supply chain. In addition, the environmental attributes can be handled according to the individual participants needs by production operating systems as described in the context of FIGS. 1 to 3. Overall, such tracking enables tracking of positive environmental impact by individual supply chain participants, which makes positive environmental impacts transparent and attributable to individual supply chain participants.

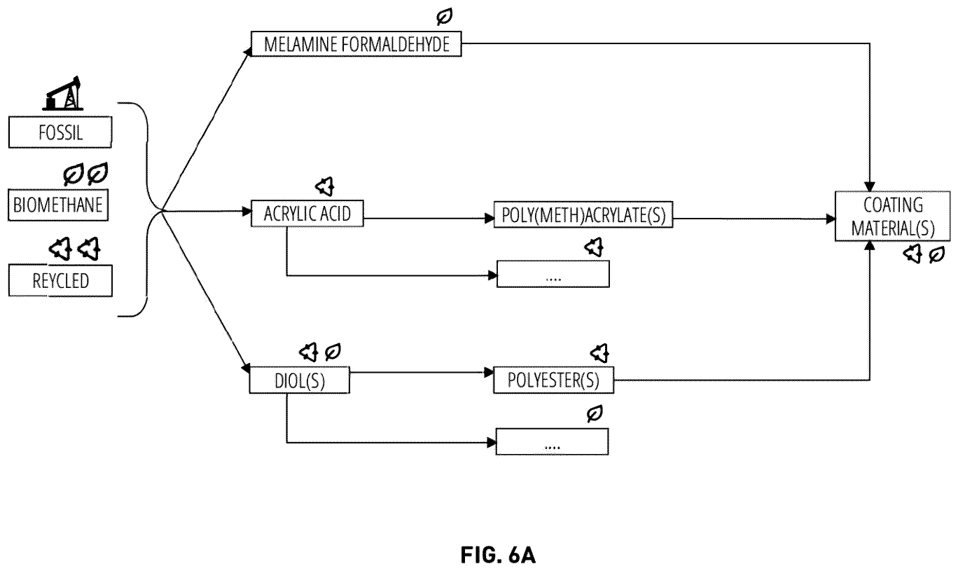

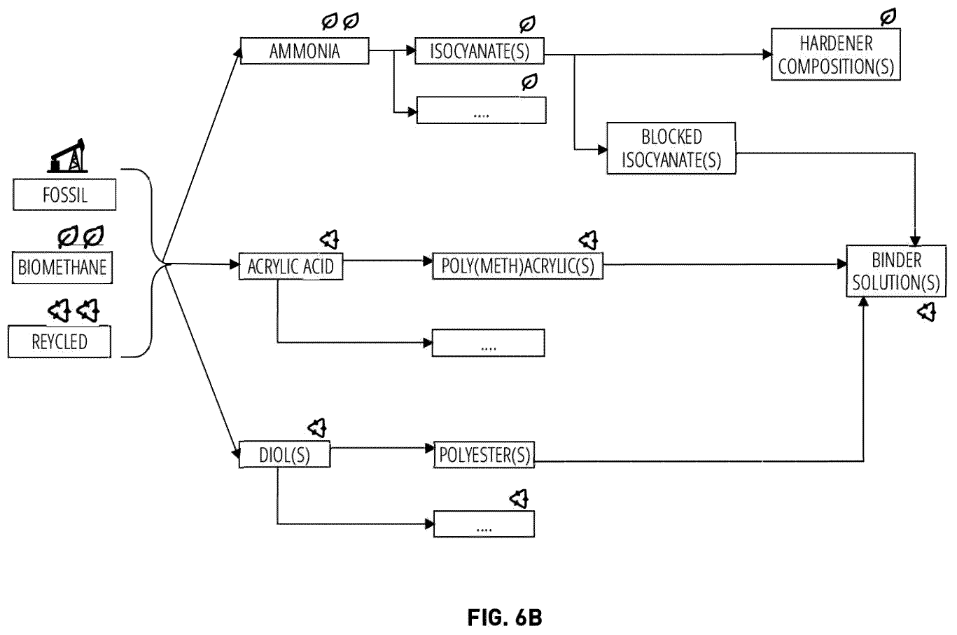

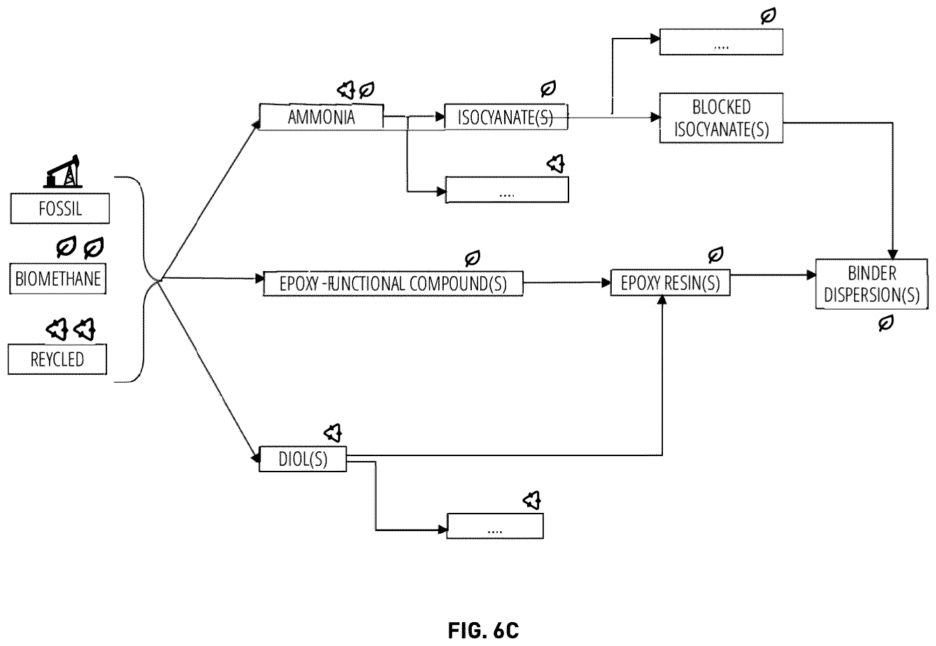

FIG. 6A illustrates schematically an example of a chemical production network for producing coating material(s) associated with a coating material passport or digital asset. The coating material(s) may be basecoat material(s), primer material(s) or clearcoat material(s). The example of FIG. 6A is an illustrative example and should not be considered limiting.

In the example of FIG. 6A, fossil feedstock, bio feedstock and recycled feedstock may be provided to the chemical production network for producing as an example coating material(s) (see for example FIGS. 1 to 5). The fossil feedstock may include natural gas or oil. The bio feedstock may include biomethane. The recycled feedstock may include pyrolysis oil. Natural gas/oil, biomethane and pyrolysis oil be the input materials in this example as mixed feedstock. Natural gas/oil, biomethane and pyrolysis oil, melamine formaldehyde, acrylic acid, diol(s) and other products, such as intermediate materials or output materials, may be produced. From acrylic acid, poly(meth)acrylate(s) and other intermediate materials or output materials may be produced. From the diol(s), polyester(s) and other intermediate materials or output materials may be produced. The melamine formaldehyde, the poly(meth)acrylate(s) and the polyester(s) may be used to produce the coating material as output material.

In the example of FIG. 6A the bio-based content of biomethane and the recycled content of pyrolysis oil as non-fossil input material may be tracked. As described in the context of FIG. 2, the biomethane content and the pyrolysis oil at the start of the coating material production chain may be registered via the production operating system 108 (not shown) of the chemical production network 104 (not shown). Here the bio-based content may be allocated to the balancing account 210 associated with metadata, such as metadata indicating that this balancing account is assigned to bio-based materials. The environmental attribute of biomethane is hence detached from the mass flows of the chemical processing in the chemical production network as illustrated in FIG. 6A. Here, the recycled content may be allocated to the balancing account 208 associated with metadata, such as metadata indicating that this balancing account is assigned to recycled materials. The environmental attribute of pyrolysis oil is hence detached from the mass flows of the chemical processing in the chemical production network 104 as illustrated in FIG. 6A.

For attribution of the biomethane content and/or pyrolysis oil content used to produce coating material, the biomethane content and/or the pyrolysis oil content may be determined. The biomethane content and/or the pyrolysis oil content attributable to the coating material production may be based on mass conservation attributable to the produced coating material. For example, only half of the bio-based content of the biomethane and only half of the recycled content of the pyrolysis oil may be attributable to the coating material and the other half may be attributable to other output products resulting from the biomethane and pyrolysis oil as input material. The environmental attribute biomethane content and/or pyrolysis oil may be attributed to such extend to the produced coating material.

The registration of the biomethane content and/or the pyrolysis oil content of the input materials as well as the attribution of said registered environmental attributes to the produced coating material may be performed as described in relation to FIG. 2. In the system shown in FIG. 2, the environmental attribute associated with the production of the coating material may be attributed to the coating material by associating the decentral ID to the coating material and assigning the environmental attribute to the decentral ID. By linking the decentral ID and the environmental attribute, the environmental attribute may be uniquely linked to the produced coating material.

The produced coating material may be delivered to a coating material consumer. The packaging, such as containers or tanks, may include a code, such as an QR-code or an embossed code. The decentral ID may be included or encoded to said code. This way the coating material consumer may access the environmental attributes associated to the produced coating material via the ID based protocol described in the context of FIGS. 4 and 5.

Similarly to this example, the registration of carbon footprint data associated with input materials and production processes as well as the attribution of said carbon footprint to the produced coating material may be based on the method illustrated in FIG. 3 for carbon footprints.

FIG. 6B illustrates schematically a further example of a chemical production network for producing a coating material component associated with a coating material passport or digital asset. The example of FIG. 6B is an illustrative example and should not be considered limiting.

In the example of FIG. 6B, fossil feedstock, bio feedstock and recycled feedstock may be provided to the chemical production network (see for example FIGS. 1 to 5) for producing as an example coating material component(s), such as binder solution(s) and hardener composition(s). The binder solution(s) may be mixing clear(s) or the binder containing component of multi-component coating materials, such as 2K clearcoat materials.

In the example of FIG. 6B, fossil feedstock, bio feedstock and recycled feedstock may be provided to the chemical production network for producing as an example binder solution(s) (see for example FIGS. 1 to 5). The fossil feedstock may include natural gas or oil. The bio feedstock may include biomethane. The recycled feedstock may include pyrolysis oil. Natural gas/oil, biomethane and pyrolysis oil be the input materials in this example as mixed feedstock. Natural gas/oil, biomethane and pyrolysis oil, ammonia, acrylic acid, diol(s) and other products, such as intermediate materials or output materials, may be produced. From ammonia, isocyanate(s), such as polyisocyanate(s) and other intermediate materials or output materials may be produced. The isocyanate(s) may be used to produce blocked isocyanate(s). The isocyanate(s) may be used to produce hardener composition(s) as output material. From acrylic acid, poly(meth)acrylate(s) and other intermediate materials or output materials may be produced. From the diol(s), polyester(s) and other intermediate materials or output materials may be produced. The blocked isocyanate(s), the poly(meth)acrylate(s) and the polyester(s) may be used to produce the binder solution(s) as output material.

In the example of FIG. 6B, the bio-based content of biomethane and the recycled content of the pyrolysis oil as non-fossil input material may be tracked as described in relation to FIG. 6A above.

For attribution of the biomethane content and/or the pyrolysis oil content used to produce the hardener composition(s) and binder solution(s), the biomethane content and/or the pyrolysis oil content may be determined. The biomethane content and/or the pyrolysis oil content attributable to the hardener composition production may be based on mass conservation attributable to the produced hardener composition(s). For example, only a half of the biomethane content may be attributable to the hardener composition(s) while the remaining biomethane and/or pyrolysis oil content may be attributable to other output products resulting from the mixed feedstock as input material. The environmental attribute biomethane content and/or pyrolysis oil content may be attributed to such extend to the produced hardener composition(s). The biomethane content and/or the pyrolysis oil content attributable to the binder solution production may be based on mass conservation attributable to the produced binder solution(s). For example, only a half of the pyrolysis oil content may be attributable to the hardener composition(s) while the remaining biomethane and/or pyrolysis oil content may be attributable to other output products resulting from the mixed feedstock as input material. The environmental attribute biomethane content and/or pyrolysis oil content may be attributed to such extend to the produced binder solution(s).

The registration of the biomethane content and/or the pyrolysis oil content of input materials as well as the attribution of said registered environmental attributes to the produced hardener composition(s) and binder solution(s) may be performed as described in relation to FIG. 2. In the system shown in FIG. 2, the environmental attribute associated with the production of the hardener composition may be attributed to the produced hardener composition by associating a decentral ID to the hardener composition and assigning the environmental attribute to the decentral ID. Likewise, the environmental attribute associated with the production of the binder solution may be attributed to the produced binder solution by associating a decentral ID to the binder solution and assigning the environmental attribute to the decentral ID. By linking the ID and the environmental attribute, the environmental attribute may be uniquely linked to the produced hardener composition and binder solution. The produced hardener composition and/or the binder solution may be delivered to the consumer of the hardener composition and/or binder solution, such as a production producing further products using the received hardener composition and/or binder solution, for example coated substrates. The packaging, such containers and/or tanks, containing the hardener composition or the binder solution may include a code, such as an QR-code or an embossed code. The decentral ID may be included or encoded to said code. This way the consumer of the hardener composition and/or binder solution may access the environmental attributes associated to the hardener composition and/or binder solution via the ID based protocol described in the context of FIGS. 4 and 5.

Similarly to this example the registration of carbon footprint data associated with input materials and production processes as well as the attribution of said carbon footprint to the produced hardener composition(s) and binder solution(s) may be based on the method illustrated in FIG. 3 for carbon footprints.

FIG. 6C illustrates schematically a further example of a chemical production network for producing a coating material component associated with a coating material passport or digital asset. The example of FIG. 6C is an illustrative example and should not be considered limiting.

In the example of FIG. 6C, fossil feedstock, bio feedstock and recycled feedstock may be provided to the chemical production network (see for example FIGS. 1 to 5) for producing as an example coating material component(s), such as binder dispersions(s). The binder dispersions(s) may be the binder containing component of multi-component coating materials, such as electrocoating materials.

In the example of FIG. 6C, fossil feedstock, bio feedstock and recycled feedstock may be provided to the chemical production network for producing as an example binder dispersions(s) (see for example FIGS. 1 to 5). The fossil feedstock may include natural gas or oil. The bio feedstock may include biomethane. The recycled feedstock may include pyrolysis oil. Natural gas/oil, biomethane and pyrolysis oil be the input materials in this example as mixed feedstock. Natural gas/oil, biomethane and pyrolysis oil, ammonia, epoxy-functional compounds, diol(s) and other products, such as intermediate materials or output materials, may be produced. From ammonia, isocyanate(s), such as polyisocyanate(s) and other intermediate materials or output materials may be produced. The isocyanate(s) may be used to produce blocked isocyanate(s) and other intermediate materials or output materials. From epoxy-functional compound(s), epoxy resin(s) and other intermediate materials or output materials may be produced. From the diol(s), polyester(s) and other intermediate materials or output materials may be produced. The blocked isocyanate(s), epoxy resin(s) and polyester(s) may be used to produce the binder dispersion(s) as output material.

In the example of FIG. 6C, the biomethane content of biomethane, the bio-content of the biomass and/or the pyrolysis oil content of the pyrolysis oil as non-fossil input material may be tracked as described in relation to FIG. 6B above.

For attribution of the biomethane content and/or the pyrolysis oil content used to produce the binder dispersion(s), the biomethane content and/or the pyrolysis oil content may be determined. The biomethane content and/or the pyrolysis oil content attributable to the binder dispersion production may be based on mass conservation attributable to the produced binder dispersion(s). For example, only a half of the biomethane content may be attributable to the binder dispersion(s) while the remaining biomethane and/or pyrolysis oil content may be attributable to other output products resulting from the mixed feedstock as input material. The environmental attribute biomethane content and/or pyrolysis oil content may be attributed to such extend to the produced binder dispersion(s).

The registration of the biomethane content and/or the pyrolysis oil content of input materials as well as the attribution of said registered environmental attributes to the produced binder dispersions(s) may be performed as described in relation to FIGS. 2, 6A and 6B by associating a decentral ID to the binder dispersion and assigning the environmental attribute to the decentral ID. By linking the ID and the environmental attribute, the environmental attribute may be uniquely linked to the produced coating material. The coating material may be delivered to the coating material consumer. The packaging, such as containers and/or tanks, may include a QR-code. The decentral ID may be included or encoded to the QR code. This way the coating material consumer may access the environmental attributes associated to the coating material via the ID based protocol described in the context of FIGS. 4 and 5.

Similarly to this example the registration of carbon footprint data associated with input materials and production processes as well as the attribution of said carbon footprint to the produced binder dispersion(s) may be based on the method illustrated in FIG. 3 for carbon footprints.

The present disclosure has been described in conjunction with preferred embodiments and examples as well. However, other variations can be understood and effected by those persons skilled in the art and practicing the claimed invention, from the studies of the drawings, this disclosure and the claims.

Any steps presented herein can be performed in any order. The methods disclosed herein are not limited to a specific order of these steps. It is also not required that the different steps are performed at a certain place or in a certain computing node of a distributed system, i.e. each of the steps may be performed at different computing nodes using different equipment/data processing.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims.

The mere fact that certain measures are recited in the mutual different dependent claims does not indicate that a combination of these measures cannot be used in an advantageous implementation.

1. A system for producing a coating material associated with a coating material passport or a digital asset, the system comprising:
a chemical production network configured to produce coating material from one or more input material(s) through one or more chemical process(es) of the chemical production network, wherein the one or more input material(s) and/ or the one or more chemical process(es) are associated with environmental attribute(s); and
a production operating apparatus configured to generate the coating material passport or digital asset by
providing a decentral identifier associated with the produced coating material; and
linking the decentral identifier to the environmental attribute(s) associated with the one or more input material(s) and/or the one or more chemical process(es).

2. The system of claim 1, wherein the coating material associated with coating material passport or digital asset is selected from coating materials or coating material components.

3. The system of claim 1, wherein the coating material passport or digital asset associated with the coating material includes mass balanced environmental attributes related to the input material(s).

4. The system of claim 1, wherein the one or more environmental attribute(s) associated with the coating material are provided from at least one balancing account configured to store environmental attribute(s) associated with input material(s).

5. The system of claim 1, wherein the one or more environmental attribute(s) are associated with at least one property related to the environmental impact of the one or more input material(s) and/or the chemical process(s).

6. The system of claim 1, wherein the production operating apparatus is configured to gather environmental attributes associated with the produced coating material before, during and/or after production of the coating material by the chemical production network.

7. The system of claim 1, wherein the environmental attribute(s) associated with the coating material produced through chemical processes from one or more input material(s) provided to the chemical production network include the environmental attribute(s) associated with the input material(s), the chemical process(es) and/or the chemical production network(s).

8. The system of claim 1, wherein the environmental attribute(s) associated with input material(s) are provided before, during and/or after production of the coating material by the chemical production network, wherein the environmental attribute(s) associated with input material(s) are allocated to at least one balancing account before, during and/or after production of the coating material by the chemical production network.

9. The system of claim 1, wherein the environmental attribute(s) associated with the produced coating material relate to environmental properties generated from process data associated with the chemical processing of the input material(s) and/or energy data associated with the energy consumption of the chemical processing.

10. A method for producing a coating material associated with a coating material passport or a digital asset, wherein the method comprises:
producing coating material from one or more input material(s) through one or more chemical process(es) of a chemical production network, wherein the one or more input material(s) and/or the one or more chemical process(es) are associated with environmental attribute(s);
generating the coating material passport or digital asset by
providing a decentral identifier associated with the produced coating material; and
linking the decentral identifier to the one or more environmental attribute(s) associated with the one or more input material(s) and/or the one or more chemical process(es); and
providing the produced coating material in association with the coating material passport or digital asset.

11. A coating material associated with coating material passport or digital asset, the passport or digital asset including a decentral identifier associated with the coating material and linked to one or more environmental attribute(s) of the one or more input material(s) and/or the one or more chemical process(s) used to produce the coating material.

12. The coating material of claim 11, wherein the coating material is selected coating materials and coating material components.

13. A method for generating a coating material passport or passport or digital asset associated with a coating material, wherein coating material is produced from one or more input material(s) through one or more chemical process(es) of a chemical production network, wherein the one or more input material(s) and/or the one or more chemical process(es) are associated with environmental attribute(s), the method comprising:
providing a decentral identifier associated with the produced coating material;
linking the decentral identifier to the environmental attribute(s) associated with the one or more input material(s) and/or the one or more chemical process(es) used to produce the coating material; and
providing the coating material passport or digital asset in association with the produced coating material passport or digital asset to a decentral network, wherein the environmental attribute(s) associated with the produced coating material is made accessible to a consumer of the produced coating material through the coating material passport or digital asset.

14. A digital asset as generated according to the method of claim 13.

15. A method for using the digital asset generated according to the method of claim 13 in production of a product produced from the coating material associated with the digital asset.

16. The system of claim 2, wherein the coating material is selected from electrocoating materials, primer materials, primer-surfacer materials, filler materials, putty materials, basecoat materials, clearcoat materials or tinted clearcoat materials and/or wherein the coating material component is selected from hardener compositions, additive compositions, thinners, reducers, spot blender compositions, pigment pastes or binder compositions.

17. The coating material of claim 12, wherein the coating material is selected from electrocoating materials, primer materials, primer-surfacer materials, filler materials, putty materials, basecoat materials, clearcoat materials or tinted clearcoat materials and/or wherein the coating material component is selected from hardener compositions, additive compositions, thinners, reducers, spot blender compositions, pigment pastes or binder compositions.

18. A method for using the coating material of claim 11 associated with the digital asset for producing a product from the coating material and deriving a digital asset associated with the product from the coating material digital asset.
